(19) United States
(12) Patent Application Publication
(10) Pub. No.: US 2012/0319807 A1
(43) Pub. Date: Dec. 20, 2012

(54) METHOD FOR PRODUCING A MAGNET, MAGNET AND ELECTRIC MACHINE

(75) Inventors: Ingo Zeitler, Tamm (DE); Ulrike Mock, Wolfsbergallee (DE)

(73) Assignee: ROBERT BOSCH GMBH, Stuttgart (DE)

(21) Appl. No.: 13/508,223

(22) PCT Filed: Oct. 29, 2010
(86) PCT No.: PCT/EP2010/066432

§ 371 Date: Aug. 15, 2012

(30) Foreign Application Priority Data
Nov. 5, 2009 (DE) 10 2009 046 426.3

(51) Int. Cl. H01F 41/02; H01F 1/36; H01F 1/00; B29C 39/02

(52) U.S. Cl. 335/296; 264/239; 252/62.51 R

(57) ABSTRACT

The invention relates to a method for producing a magnet (1), wherein the magnet (1) is formed from at least one magnetic material (3) and one binding agent (4) and is subsequently hardened. According to the invention, a metal oxide (8) that is chemically bonded to the magnetic material (3) is produced from the binding agent (4) during hardening. The invention further relates to a magnet (1) and an electric machine.

### BACKGROUND OF THE INVENTION

The invention relates to a method for producing a magnet, wherein the magnet is formed from at least one magnetic material and one binding agent and is subsequently hardened. The invention further relates to a magnet and an electric machine.

Methods of the kind mentioned above are known from prior art. The magnetic material is, for instance, metal or ferrite. The magnetic material is thereby present as a powder, which is sintered or pressure-sintered in order to produce the magnet. The magnetic material can also alternatively or additionally be mixed with the binding agent. The magnet is subsequently formed and hardened from the mixture of magnetic material and binding agent. The forming of said magnet can thereby comprise, for example, casting or injection-molding. The binding agent can be a plastic, particularly PPS (polyphenylene sulfide), or comprise such an organic polymer. After the magnet has hardened, the magnetic material is physically enclosed by the binding agent or respectively integrated in the same. If a magnet produced in this manner comes however in contact with oxygen or a corrosive medium, said magnet tends to significantly corrode, which makes a protection of the magnet necessary. Metallic protective coatings containing nickel and/or zinc are used extensively for this purpose. Particularly pressure-sintered magnets are protected from corrosion with said protective coatings. Oxidic protective coatings are likewise known, which are applied to the magnet in the form of a solution of a metal alkoxide in a solvent. The production of the magnet by mixing the magnetic material with the binding agent has a significantly higher level of flexibility with respect to the direct sintering of the magnetic material for many applications and is therefore to be preferred. A certain protection of the magnetic material from corrosion is likewise ensured by integrating said magnetic material into the binding agent, for example, into plastic (preferably in the form of synthetic granules). Particularly when the magnet comes in contact with fuels and additives thereof, heavy corrosion forms on such a magnet in a short time and can eventually lead to the breakdown of one of the systems comprising the magnet.

### SUMMARY OF THE INVENTION

In contrast thereto, the method has the advantage that the magnet produced is more resistant to corrosion than magnets known from prior art, in particular with respect to fuels and the additives thereof. According to the invention, this corrosion resistance is achieved by a metal oxide chemically bonded to the magnetic material being produced from the binding agent during hardening. After hardening, a matrix of the metal oxide is then present, in which the magnetic material is enclosed or embedded. In so doing, the metal oxide matrix is chemically bonded to the magnetic material. Said magnetic material is therefore held by the metal oxide matrix or respectively the metal oxide structure. With a magnet produced in this way, it is not necessary to provide an additional protective coating. In the case of binding agents known from prior art, particularly organic binding elements as, for example, engineering plastics (PPS), a swelling results when there is contact with a corrosive medium like fuel, said swelling increasing the permeation of corrosion-promoting substances as, e.g., water and salts. Moreover, as pointed out above, the magnetic material is only physically integrated into the binding agent. There is no chemical bond present between the magnetic material and the binding agent, whereby by the onset of corrosion, the permeation of corrosion-promoting substances into the magnet is actually increased. Such a permeation cannot occur with a magnet, which is produced in accordance with the inventive method, because the magnetic material is chemically bonded to the metal oxide.

For example, a siloxane based binding agent is used. Due to the chemical structure of such a binding agent, a chemical bond of the magnetic material to the binding agent, respectively the siloxane matrix, results. The latter is impermeable. The chemical bonding of said magnetic material to the binding agent as well as the impermeable siloxane matrix contribute to a drastically increased corrosion protection. In addition, thickeners and/or yield point formers (like partially cross-linked polyacrylic acid) can be used in order to prevent a sedimentation of said magnetic material.

Provision is made in a modification to the invention for the metal oxide to be produced in a sol-gel process. The magnetic material is therefore integrated into a metal oxide matrix, which protects against corrosion and is produced by the sol-gel process. Said sol-gel process serves to produce non-metallic, inorganic or hybrid polymer materials from colloidal dispersions. The latter are also referred to as sols. The sol can thereby originate from different precursors. The sol is changed into a gel by means of gelification, wherein the latter represents a colloid. During the sol-gel process, the network building of the metal oxide occurs, which is in other words the chemical bonding of the magnetic material to said metal oxide.

Provision is made in a modification to the invention for at least one rare earth material to be used as the magnetic material. Magnets made from rare earth materials surpass the performance of conventional magnets made from iron many times over and are preferably used for that reason. The elements scandium, yttrium and lanthanum as well as lanthanide are known as rare earth metals. The latter includes cerium, praseodymium, neodymium, promethium, samarium, europium, gadolinium, terbium, dysprosium, holmium, erbium, thulium, ytterbium and lutetium. The rare earth material comprises at least one rare earth metal. For example, an alloy consisting of neodymium, iron and boron (Nd₂Fe₁₄B) is used. Magnets, which contain the rare earth material, are however once again more susceptible to corrosion than conventional magnets. For that reason, provision is made for a metallic protective coating particularly for pressure-sintered magnets from such a magnetic material, wherein said coating comprises particularly nickel and/or zinc. As already described above, the oxidic protective coating can alternatively be used, wherein a metal oxide solution is applied to the magnet. Said protective coating can usually be omitted if the magnetic material is embedded in the metal oxide matrix; however, can be additionally provided to achieve a better protection.

Provision is made in a modification to the invention for at least one siloxane, one silane, in particular an alkoxysilane or an ethoxysilane, particularly preferred a tetraethoxysilane, one metal halide, one metal alkoxide and/or metal oxide nanoparticles to be used as a constituent part of the binding agent. The aforementioned materials thereby constitute the so-called precursors. The use of only one precursor or a combination of several precursors is thereby possible. Different silicon alkoxides can particularly be used, as, e.g., tetraethoxysilane (TEOS) and the variant forms thereof. With regard to the latter, one or several alkoxide groups are replaced by organic molecules. The resultant materials are also referred to as organofunctional silanes. The ethoxysilanes can likewise be used. In these cases, silicic acid is technically esterified with ethanol groups. Materials can alternatively be used, in which the silicic acids are esterified with alcohols, as, for example, methanol, propanol, butanol and the like, diols, as, e.g., glycol, porpandiol or the like, or triols, as, e.g., glycerine.

The binding agent can also comprise precursors of zirconium, aluminum, cerium, titanium and/or other transition metals. Metal oxide nanoparticles, in particular from Al₂O₃ZrO₂ and/or TiO₂, and/or inorganic nanoparticles can additionally or alternatively be used. Silicic acid, in particular pyrogenic silicic acid, can be a constituent part of the binding agent. The silanes mentioned above, in particular alkoxysilane, react with water to silicic acid, which subsequently condenses with itself to a 3D network of metal oxide (in this case: SiO₂). Primarily volatile reaction products are subsequently removed. Precursors, which can be polymerized to a metal oxide or respectively to a metal oxide matrix without the addition of water, are also available for water-sensitive magnetic materials. These include combinations of metal halides (for example: monochloro-, dichloro- or trichloromethylsilanes) with metal oxides (for example: tetraethoxysilane (TEOS) or all of the variants already mentioned above). Metal halides are more reactive than metal oxides. This is why in combinations of this kind, the polymerization can be started by a simple increase in temperature of the magnetic material/binding agent mixture. The 3D-metal oxide matrix, which includes the magnetic material and is chemically bonded to the same, is formed in turn in this way. Only haloalkanes (alkyl halides) result as by products, which after production of the magnet are removed together with any possibly present solvent. Instead of the previously listed elements zirconium, aluminum, cerium, titanium and the other transition metals, compounds of said elements can also be used as precursors.

Provision is made in a modification to the invention for the binding agent and/or the magnetic material be introduced into a solvent. The solvent is primarily provided for the purpose of simplifying the processing of the magnetic material and/or the binding agent, particularly for the purpose of facilitating the forming of the magnet. The solvent is preferably withdrawn from the magnet during the hardening of the same. The solvent can be water and/or alcohol or respectively comprise water and/or alcohol. An aprotic solvent can also be alternatively or additionally used. The magnetic material and the binding agent are dispersed into the solvent.

Provision is made in a modification to the invention for an additive, particularly one consisting of nanoparticles, a polymer solution and or silicic acid, to be supplied to the binding agent and the magnetic material. Prior to forming the magnet, the additive is therefore added to the mixture of magnetic material and binding agent. The additive can thereby comprise nanoparticles, the polymer solution and/or the silicic acid. The nanoparticles are, for example, nanoparticles from metal oxides, whereas the polymer solution is preferably an organic polymer solution and the silicic acid a pyrogenic silicic acid. If the solvent is provided, the additive is then dispersed into the same.

Provision is made in a modification to the invention for the magnetic material, the binding agent and/or the solvent to be poured into a mold, in which the hardening is carried out. The magnet is accordingly a molded part. During the hardening procedure, the magnetic material is chemically bonded to the metal oxide, as this forms the metal oxide matrix. The magnet can therefore be produced in practically every form by said magnetic material, said binding agent and/or said solvent being poured into a mold. Said hardening procedure is carried out in the mold. In so doing, the hardening can occur prior to a drying and/or sintering process or during the same. In the former case, the metal oxide is, for example, initially produced by means of a sol-gel process and subsequently a drying process is carried out in order to remove any possibly present solvent from the magnet. Provision can, however, alternatively be made for the hardening to be carried out at the same time as the drying and/or sintering process, particularly if said hardening procedure takes place by exposing the magnet or rather the magnetic material/binding agent mixture to heat. It is also possible to apply a magnetic coating to a surface by the direct application of the magnetic material and the binding agent, preferably dissolved in the solvent. Said coating can be applied with the aid of conventional application techniques as, for example, spraying, dip coating, rolling, spin coating and the like, in particular also for large areas. Segmented, magnetic surfaces can alternatively be selectively formed, for example using a mask.

Provision is made in a modification to the invention for the magnet to be provided at least in certain areas with a coating, in particular a sol-gel coating. The magnet consisting of magnetic material and the metal oxide chemically bonded to the same is very well suited to chemically bonding the coating particularly if provision is made for the sol-gel coating. A sol-gel lacquer is preferably used to apply the coating. In so doing, a functional sol-gel lacquer is used in order to bring out the additional surface effects. In this way, the corrosion resistance of the magnet can be further increased. In principle, provision can however be made for any type of coating.

The invention further relates to a magnet, particularly one produced using the previously described method, wherein the magnet is at least formed from a magnetic material and a binding agent and is subsequently hardened. Provision is thereby made for the magnetic material to be enclosed in a metal oxide, which is produced during hardening and is chemically bonded to the magnetic material. The magnet is thereby characterized in that it already has an extremely high corrosion resistance without an additional coating, in particular when there is contact with fuels and the additives thereof. For this reason, the magnet is highly suited for use in electric machines, particularly electric motors, for example as part of a fuel pump. The magnet can generally be used for all magnetic components, which possibly can come in contact with fuel or have complex geometries that cannot be produced or can only be produced with great difficulty by means of plastic injection molding processes or sintering processes.

The invention further relates to an electric machine, in particular an electric motor comprising at least one magnet particularly according to the preceding embodiments and particularly manufactured using the method according to said preceding embodiments, wherein the magnet is formed from at least one magnetic material and one binding agent and is subsequently hardened. Provision is thereby made for the magnetic material to be enclosed in a metal oxide which is produced during hardening and is chemically bonded to said magnetic material. The metal oxide is produced from the binding agents during hardening. In this way, an excellent dimensional stability as well as a good corrosion resistance is ensured.

### BRIEF DESCRIPTION OF THE DRAWINGS

The invention is explained in detail using the exemplary embodiments depicted in the drawings without said invention being limited to the explanations and drawings presented. In the drawings:

FIG. 1 shows an exemplary embodiment of a magnet,

FIG. 2 shows a schematic depiction of an initial manufacturing step of the magnet,

FIG. 3 shows a schematic depiction of a further manufacturing step of the magnet, and

FIG. 4 shows a schematic structural view of the magnet, wherein said magnet comprises a magnetic material and a metal oxide chemically bonded thereto.

### DETAILED DESCRIPTION

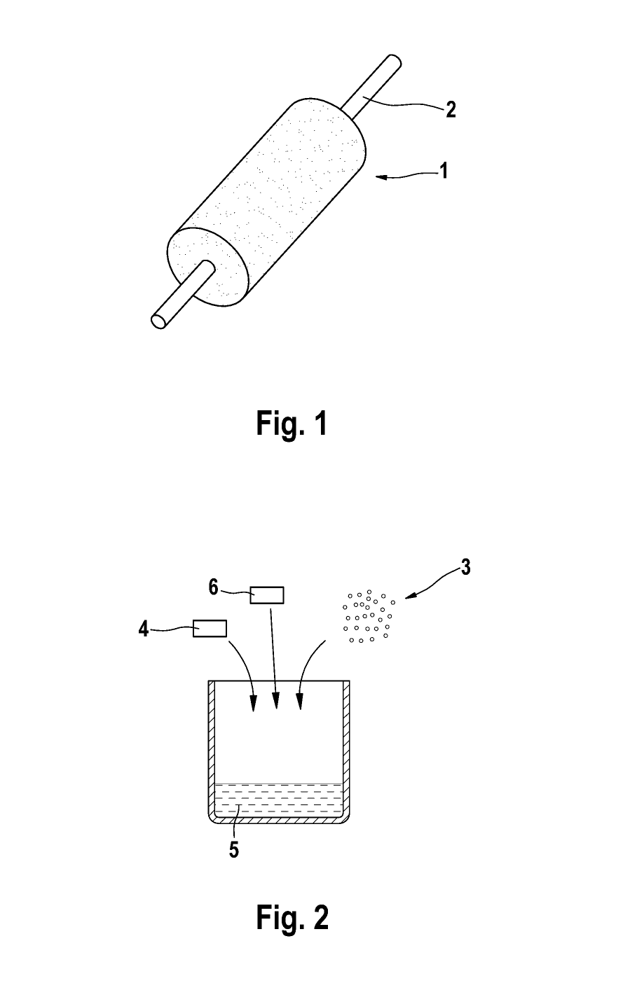

FIG. 1 shows a magnet 1 which is fastened to a shaft 2 that is made of metal. The magnet 1 is preferably molded to the shaft 2 and thereby fastened thereto. Said magnet 1 consists of a magnetic material 3 (not depicted here) and a binding agent 4 (likewise not depicted here), which are conjointly formed and subsequently hardened. During hardening, a metal oxide is produced from the binding agent, said metal oxide being chemically bonded to the magnetic material and forming a metal oxide matrix that encloses said magnetic material. In this way, said magnetic material 3 of the magnet 1 is protected from external influences, in particular corrosive influences.

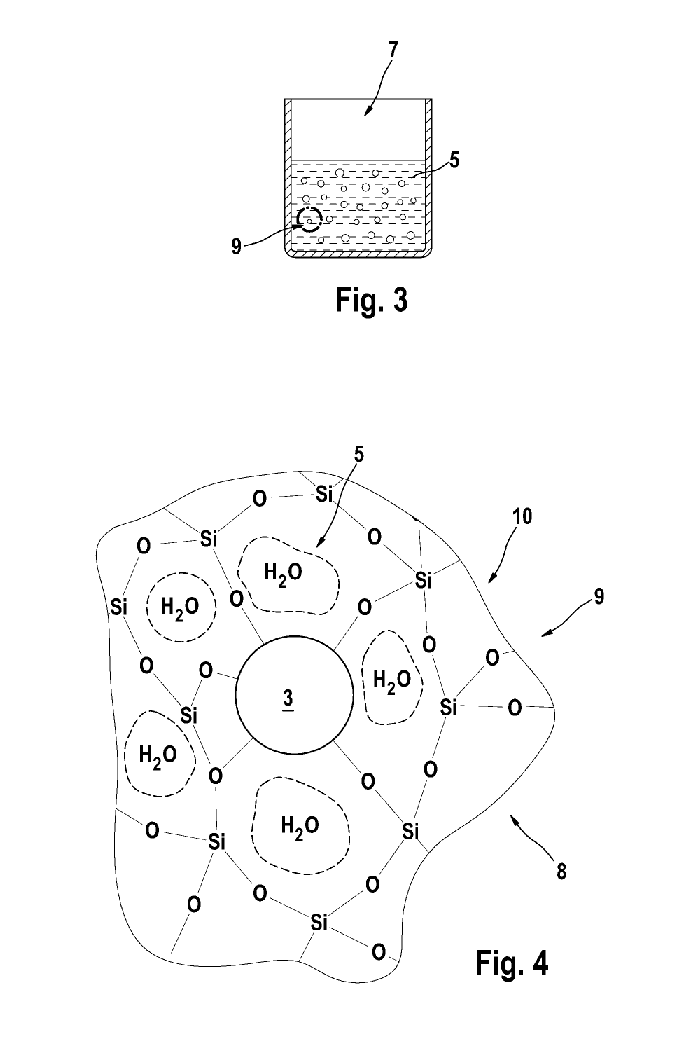

FIG. 2 shows an initial manufacturing step for producing the magnet 1. The magnetic material 3, the binding agent 4 and one or several additives are dispersed into a solvent 5 so that a homogeneous dispersion consisting of magnetic material 3, binding agent 4, solvent 5 and additive 6 results. The dispersion is used as the sol in a sol-gel process. The sol is gelled to a gel (“wet gel”) during said process. In so doing, metal oxide 8 is produced from the binding agent 4. The metal of the metal oxide is thereby, for example, SiO₂, ZrO₂, Al₂O₃ or the like. At least after hardening, the metal oxide 8 is chemically bonded to the magnetic material 3. Such a bond 9 is highlighted in FIG. 3 and is enlarged in FIG. 4.

FIG. 4 shows a section of the bond 9 consisting of magnetic material 3 and metal oxide 8. The metal oxide is SiO₂ in the example that is depicted. Water (H₂O) is introduced as the solvent 5. In principle, other metals such as, for example, Zirconium or aluminum can however be substituted for the silicon. A rare earth material is preferably used as the magnetic material such as, for example, Nd₂Fe₁₄B, which therefore comprises neodymium. Such a magnet 1 is considerably more powerful than magnets made from conventional magnetic materials, as, for example, iron or ferrite. As a result of the chemical bond between magnetic material 3 and metal oxide 8, the magnet 1 is extremely resistant to corrosion. A matrix 10, which is formed from the metal oxide 8, is in addition advantageously impermeable so that the permeation of corrosion-promoting substances into the matrix 10 is at least partially prevented.

The magnet 1 is preferably cast as a molded part, wherein said casting results in a form, in which the hardening can also be implemented. As an alternative, the magnetic material 3 and the binding agent 4, particularly after having been introduced into the solvent 5, can be directly applied to a surface in order to produce a magnetic coating. It is also possible to employ a masking technique during the aforementioned application in order, for example, to selectively produce a segmented magnetic surface.

1. A method for producing a magnet (1), wherein the magnet (1) is formed from at least one magnetic material (3) and one binding agent (4) and is subsequently hardened, characterized in that a metal oxide (8) that is chemically bonded to the magnetic material (3) is produced from the binding agent (4) during hardening.

2. The method according to claim 1, characterized in that the metal oxide (8) is produced in a sol-gel process.

3. The method according to caim 1, characterized in that at least one rare earth material is used as the magnetic material (3).

4. The method according to claim 1, characterized in that at least one siloxane, one silane, one metal halide, one metal alkoxide and/or metal oxide nanoparticles are used as a constituent part of the binding agent (4).

5. The method according to claim 1, characterized in that the binding agent (4) and the magnetic material (3) are introduced into a solvent (5).

6. The method according to claim 1, characterized in that an additive (6), a polymer solution and/or silicic acid, is supplied to the binding agent (4) and/or the magnetic material (3).

7. The method according to claim 5, characterized in that the magnetic material (3), the binding agent (4) and/or the solvent (5) are poured into a mold, in which the hardening is carried out.

8. The method according to claim 1, characterized in that the magnet (1) is provided at least in certain areas with a coating.

9. A magnet (1), produced using the method according to claim 1, wherein the magnet (1) is formed from at least one magnetic material (3) and one binding agent (4) and is subsequently hardened, characterized in that the magnetic material is enclosed in a metal oxide (8) that is produced during hardening and is chemically bonded to said magnetic material (3).

10. An electric machine, comprising at least one magnet (1), according to claim 9, wherein the magnet (1) is formed from a magnetic material (3) and a binding agent (4) and is subsequently hardened, characterized in that the magnetic material is enclosed in a metal oxide (8) that is produced during hardening and is chemically bonded to said magnetic material.

11. The method according to claim 1, characterized in that the at least one silane is an alkoxysilane.

12. The method according to claim 1, characterized in that the at least one silane is an ethoxysilane.

13. The method according to claim 1, characterized in that the at least one silane is a tetraethoxysilane.

14. The method according to claim 1, characterized in that the binding agent (4) is introduced into a solvent (5).

15. The method according to claim 1, characterized in that the magnetic material (3) is introduced into a solvent (5).

16. The method according to claim 6, characterized in that the additive (6) consists of nanoparticles.

17. The method according to claim 8, characterized in that the coating is a sol-gel coating.

18. The electric machine according to claim 10, characterized in that the electric machine is an electric motor.
